(19) United States
(12) Patent Application Publication
(10) Pub. No.: US 2006/0237164 A1
(43) Pub. Date: Oct. 26, 2006

(54) Assembly array for an air conditioner with a heating device

(75) Inventors: Karim-Mathieu Bouchalat, Stuttgart (DE); Jörg Digele, Freiberg (DE); Gebhard Schweizer, Leonberg (DE); Werner Schenkewitz, Stuttgart (DE)

Correspondence Address: FOLEY AND LARDNER LLP;SUITE 500, 3000 K STREET NW, WASHINGTON, DC, 20007, US

(73) Assignee: BEHR Gmbh & CO. KG

(21) Appl. No.: 10/563,796

(22) PCT Filed: Jun. 15, 2004
(86) PCT No.: PCT/EP04/06437

§ 371 Date: Jun. 27, 2006

(30) Foreign Application Priority Data
Jul. 9, 2003 (DE) 103311238
Feb. 13, 2004 (DE) 1020040075115

(51) Int. Cl. B60H 3/00; B60H 1/00; B61D 27/00; B60H 1/02

(52) U.S. Cl. 165/42; 165/202; 237/12.6

(57) ABSTRACT

The invention relates to an assembly array for an air conditioner with a heating device, particularly for motor vehicles, comprising at least one housing in which air is guided in an at least partly predetermined flow path. The flow path also receives at least one heating device and at least one control device, wherein the heating device is arranged in a first flow path and the control device is partly arranged in a second flow path. The control device is arranged relative to the heating device in such a way that it provokes almost completely the through-flow of the heating device.

The invention relates to an installation arrangement for an air-conditioning system with a heating apparatus, in particular for use in motor vehicles.

Devices for cooling air which is fed into the passenger compartment of a motor vehicle are known in the prior art. However, these designs have the disadvantage that additional installation space has to be provided in order to integrate, for example, an additional heater in the device. In addition, in the prior art recirculated air is heated by means of an additional heating apparatus, in which case additional fans are necessary to ensure sufficient air supply into the passenger compartment.

The object of the present invention is to make available an installation arrangement for an air-conditioning system with at least one heating apparatus, in particular for motor vehicles, which installation device reduces the problems known in the prior art and is cost effective to manufacture.

The object is achieved by means of the subject matter as claimed in claim 1. Further exemplary embodiments are the subject matter of the subclaims.

The installation arrangement according to the invention for an air-conditioning system with a heating apparatus, in particular for motor vehicles, has at least one housing in which air is guided in an at least partially predefined flow path. In this context, the flow path is formed both by the inside of the housing and by additional elements and/or components. In addition, at least one heating apparatus and at least one actuating device are accommodated within the housing, the heating apparatus being preferably arranged in a first flow path and the actuating device being preferably arranged at least partially in another, in particular a second flow path.

According to the present invention, the actuating device is arranged in such a way that at least in one position, in particular a closed position, it causes the air to flow essentially completely through the heating apparatus.

An actuating device is preferably understood to be a device or a component which is mounted so as to be capable of rotating at least about one axis and is arranged in the flow path in such a way that the flow path is influenced in its flow cross section by the actuating device.

At least in one position, the actuating device is preferably in contact with one section of the heating apparatus. In one preferred embodiment, the actuating device is thus, for example, a rotatable flap whose center of rotation is arranged offset from the outer contour of the heating apparatus by half the width of the flap and which, in the closed position, is at least partially in contact both with the outer contour of the heating apparatus and of the inner contour of the second flow path.

The installation arrangement for an air-conditioning system with a heating apparatus preferably has at least one inlet, in particular an inlet opening, and at least on outlet, in particular an outlet opening, for the air. According to a further particularly preferred exemplary embodiment, it is possible, in particular, also to provide a plurality of inlets for, for example, external air or fresh air and/or recirculated air or else a plurality of outlets for various positions, in particular in the vehicle cab, such as the front window, the foot well or the like.

According to one particularly preferred embodiment, the installation arrangement for an air-conditioning system with a heating apparatus has a heating apparatus which is selected in particular from a group of heating apparatuses which contains heat exchangers, in particular heat pumps, CO₂ heat pumps, heaters which use exhaust gas heat, fuel heaters, condensers, stationary-mode heaters, electric heaters, PTC heaters, combinations thereof and the like.

The heating apparatus of an installation arrangement according to the invention preferably has at least one heat-conducting core whose heat-exchanging surfaces are formed by baffle plates which are arranged, in particular, on the surface of the core in a heat-conducting fashion. The heat-exchanging surfaces are arranged at a predefined angle to the main direction of extent of the core, in particular its center axis. According to one particularly preferred exemplary embodiment, this angle is between 0 degrees and 90 degrees, preferably between 45 degrees and 90 degrees, particularly preferably between 75 degrees and 90 degrees, and in particular is approximately 90 degrees.

In one embodiment of the invention, the geometric center points of the heat-exchanger surfaces are arranged essentially on the longitudinal center axis of the heat-conducting core and at a predefined distance from one another.

According to a further preferred embodiment, the surfaces of heat exchanger surfaces are square, circular, elliptical, polygonal, combinations thereof or the like, with essentially quadratic surfaces being used according to one particularly preferred embodiment.

In one particularly preferred embodiment of the present invention, the air which flows through the heating apparatus flows around at least part of the surface of the heat-conducting core. This is also to be understood as a flow in which the flow of the air flowing through the heating apparatus does not surround the heat-conducting core of the heating apparatus but rather merely extends along part of the surface of the heat-conducting core. The cross section of the heat-conducting core is particularly preferably embodied in such a way that the air flowing along such a part flows at least essentially in a laminar fashion, that is to say no, or only a few flow eddies occur in the surroundings of the heat-conducting core, which flow eddies may occur, for example, owing to the speed of the flow and owing to the surface condition and of the surface shape of the heat-conducting core.

In one particularly preferred embodiment of the present invention, the cross-sectional shape of the heat-conducting core is of asymmetrical design. The asymmetry of the heat-conducting core is particularly preferably formed here in such a way that the air which flows through the heating apparatus flows around the heat-conducting core in a better way, for example flows around in a better way by virtue of the fact that the asymmetry produces increased ram pressure on the inflow side of the heating apparatus and as a result there is improved transfer of heat between the core and the air flowing around it.

In one embodiment of the invention, the heating apparatus adjoins at least one element which at least partially bounds the first and/or second flow paths or is connected, for example, to the heat-exchanging surfaces or else to the heat-conducting core.

In one preferred embodiment, a free cross section through which part of the air flowing through the heating apparatus flows is formed between the heat-conducting core and the element which bounds the flow path. In this way it is possible to ensure that even if a high heat is generated at the heating apparatus thermal overloading of even damage to the element adjoining the heating apparatus can be prevented since the air flowing through the free cross section cools the surface of the heat-conducting core or the heat-exchanging surfaces. It is particularly preferred also for that part of the air flowing through the heating apparatus which flows through the free cross section to be essentially laminar in the region of the surface of the heat-conducting core so that no, or only few, eddies of the air flowing through the heating apparatus occur.

In one particularly preferred embodiment of the present invention, the heat-conducting core has a third flow path which is arranged within the heat-conducting core and through which a heating medium which heats the heat-conducting core flows.

The heating medium is preferably a fluid, preferably a gas, and particularly preferably an exhaust gas of a combustion process. The heating medium which flows through the heat-conducting core flows here particularly preferably along a predefined flow path which is embodied in such a way that the heat which is transferred from the heating medium to the heat-conducting core gives rise to an at least partially asymmetrical temperature distribution along the surface of the heat-conducting core.

The heating medium which flows through the heat-conducting core preferably brings about a temperature gradient over the cross section of the heat-conducting core as it flows along the third flow path. This temperature gradient causes the temperature difference between the respective part of the heat-conducting core around which the air flows and the heat-exchanging surfaces which are in contact with it and the air flowing around this part to be at a maximum, and as a result of this there is a particularly efficient transfer of heat between the heating medium and the air.

In one particular preferred embodiment, the temperature gradient is oriented over the cross section of the heat-conducting core here in such a way that it is at least partially parallel with the temperature gradient of the air flowing through the heating apparatus. This makes possible a situation in which the temperature difference between the respective part of the heat-conducting core around which there is a flow and the air flowing in this part does not diverge along the flow path of the air through the heating device so that there is no resulting inefficient transfer of heat.

A further embodiment of an installation arrangement according to the invention also has at least one cooling device for the air, in which case in particular vaporizers or corresponding devices such as are known in the prior art are used.

According to a further preferred embodiment, the heating apparatus is arranged in a first flow path, in which case it is also within the sense of the present invention to arrange the heating apparatus in a bypass duct in such a way that depending on the position of the actuating device in the main duct the air flowing through the heating element, and thus heating of the air, are influenced. This applies correspondingly also to the arrangement of a cooling device such as, for example, a vaporizer, Peltier element or the like.

According to one preferred embodiment, the heating apparatus is arranged at a predefined distance from the outer wall of the housing, in which case, according to one further preferred embodiment, the outer wall of the housing is made to extend at least partially along a dividing wall adjoining an internal combustion engine, and, according to one preferred exemplary embodiment at least one heating apparatus, in particular for heating the air, is arranged in this region.

According to one further exemplary embodiment, the heat-exchanging surface of the heating apparatus is arranged on the longitudinal center axis of the motor vehicle at a predefined angle between 0 degrees and 180 degrees, preferably between 0 degrees and 90 degrees.

The installation arrangement for an air-conditioning system with a heating apparatus has, according to one further preferred exemplary embodiment, at least one fan which is arranged within the housing and is preferably operated with electrical energy. The use of such a fan promotes the movement of the air within the housing along the flow paths.

According to the invention, the air is fed out directly and/or indirectly into the passenger compartment of the motor vehicle, in which case, as already stated, not only an individual outlet has to be provided but also use of a plurality of outlets lies within the sense of the present invention. Direct is understood here to mean a virtually direct outlet which opens into the passenger compartment. In particular an air feeding means which is connected to additional components or actuating elements via a further flow path and subsequently opens into the passenger compartment is understood to be indirect.

The actuating device is preferably arranged in a rotatable fashion and according to one preferred exemplary embodiment can be moved into at least two different positions, as a result of which at least one flow path is opened or closed. According to a further particularly preferred exemplary embodiment, the actuating device can also be set in an infinitely variable fashion, in which case, depending on the position of the actuating device, the proportion of air which is fed, in particular, through the heating apparatus and/or past the heating apparatus can be changed and thus closed-loop and/or open-loop control can be performed on it.

In one particularly preferred embodiment of the present invention, a second actuating device which essentially prevents air from flowing back counter to the main direction of flow of the first flow path, and in particular through the heating apparatus, is arranged in the first flow path, connected downstream of the heating apparatus. The second actuating device prevents air from flowing back, in particular if a flow of air through the heating apparatus is to be reduced, or else avoided, by opening the first actuating device.

The second actuating device is in this case preferably embodied in such a way that it is at least partially opened by the air flowing through the heating apparatus and/or the first flow path, as a result the flow of air through the heating apparatus along the first flow path is made possible.

This is advantageous in particular since the second actuating device fulfils the function of a nonreturn valve without complex or expensive actuating elements for influencing the position of the second actuating device being necessary for this purpose.

According to one particularly preferred embodiment, an actuating element which is embodied in particular in the form of a spring or of a weight which promotes the closing movement of the actuating device or the like counteracts the opening movement of the second actuating device as the air flows through the first flow path, to such an extent that a predefined pressure of the air flowing into the first flow path or the heating apparatus has to be present for the second actuating element to open and the flow of air through the heating apparatus to be made possible.

Both the first actuating device and the second actuating device are particularly preferably selected from a group of actuating devices which includes actuating flaps, in particular actuating flaps which are mounted on one side or centrally, swing flaps, segmented flaps, wing flaps, shutters, in particular iris shutters and the like.

The device for exchanging heat also has, in the inlet region of the air, a device for filtering the air in order, in particular when external air is introduced, to retain the contamination such as dust, leaves or the like, which is possibly carried in with it, so that soiling and premature wear of the device is at least partially prevented.

In addition, the inlet region and/or outlet region in the air has a closed-loop and/or open-loop control device which performs closed-loop or open-loop control on the quantity of inflowing or outflowing air.

According to the present invention, such closed-loop or open-loop control devices may be, for example, flaps or segments which are arranged in the region of the inlet and/or outlet and are changed in their position manually or electrically or the like by means of an adjusting device.

The device also has at least one sensor which is selected from a group of sensors which determine the temperature, pressure, speed of the medium or the position of a component and the like.

According to one further particularly preferred embodiment, one sensor is connected to a control device which uses the data acquired therefrom for performing open-loop and/or closed-loop control of the device. Such an open-loop control device is known in the prior art and does not require any further explanation.

According to one further particularly preferred embodiment, the individual elements and/or assemblies of the device are basically arranged one behind the other in the direction of flow. According to a further particularly preferred embodiment it is however possible to remove at least individual elements and/or assemblies from a first main flow path of the air and to connect them at least partially or completely to the flow path of the air when required by means of a bypass, for example.

In addition, it is also within the sense of the present invention to connect a plurality of flow paths in parallel one next to the other, in which case the flow through the individual flow paths can be opened or closed by means of an actuating element.

According to one particularly preferred embodiment, the actuating devices are arranged in such a way that, in particular when the heating apparatus is bypassed, a drop in pressure within the flow path can be largely reduced and the installation space is reduced compared to the prior art by the compact arrangement of the actuating devices.

The invention and further advantages are explained below in a plurality of exemplary embodiments, in which case the invention will not be restricted by this. In the drawings:

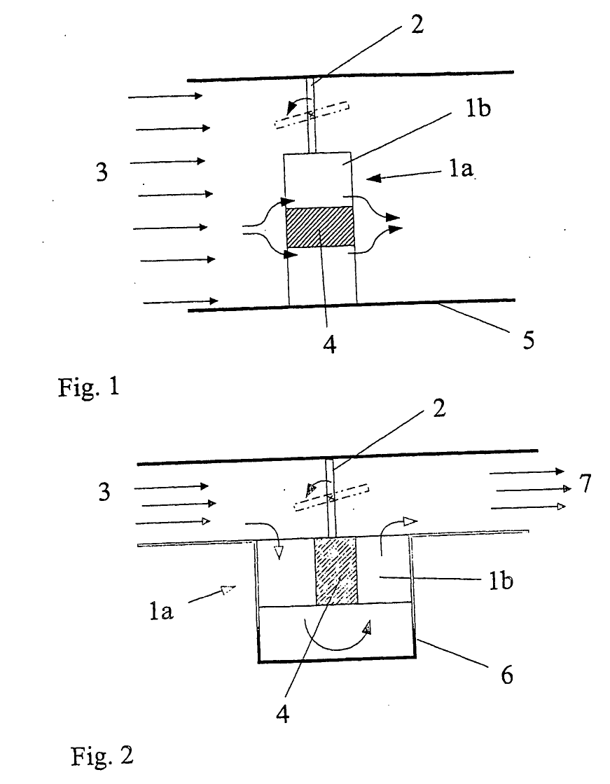

FIG. 1 shows a schematic arrangement of an arrangement according to the invention of a heating apparatus and an actuating device;

FIG. 2 is a schematic illustration of an alternative arrangement of a heating apparatus and of an actuating device according to the present invention;

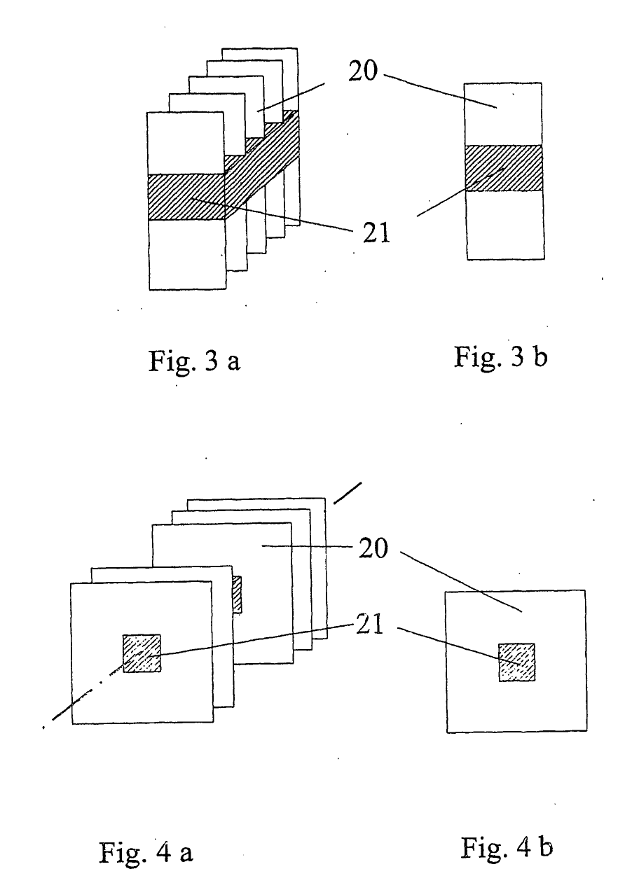

FIG. 3a is a perspective illustration of a heat exchanger surface with a heating core;

FIG. 3b is a side view of the heat exchanger surface from FIG. 3a;

FIG. 4a is a perspective illustration of a further exemplary embodiment of a heat exchanger surface according to the invention with a heat-conducting core;

FIG. 4b is a side view of the heat exchanger surface from FIG. 4a;

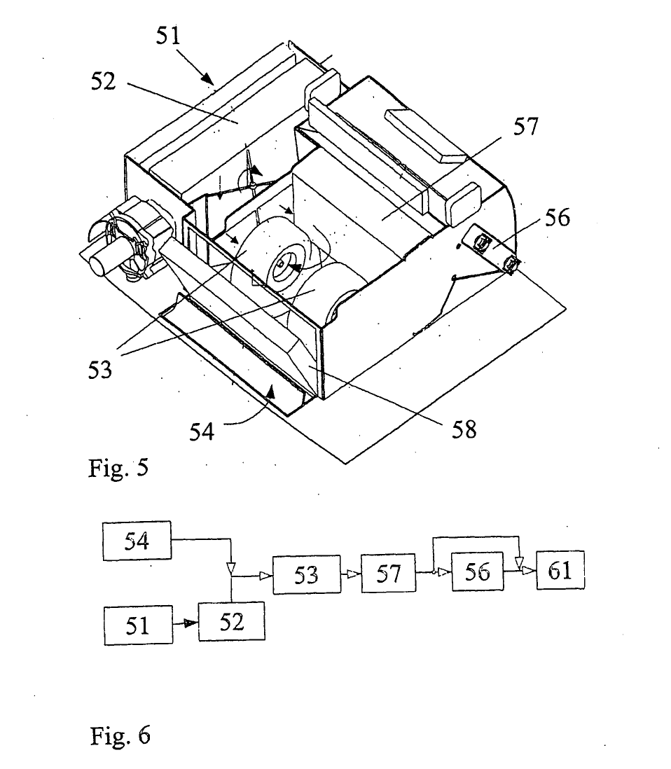

FIG. 5 is a perspective illustration of an installation arrangement according to the invention for an air-conditioning system with a heating apparatus;

FIG. 6 is a flow chart of the device from FIG. 5;

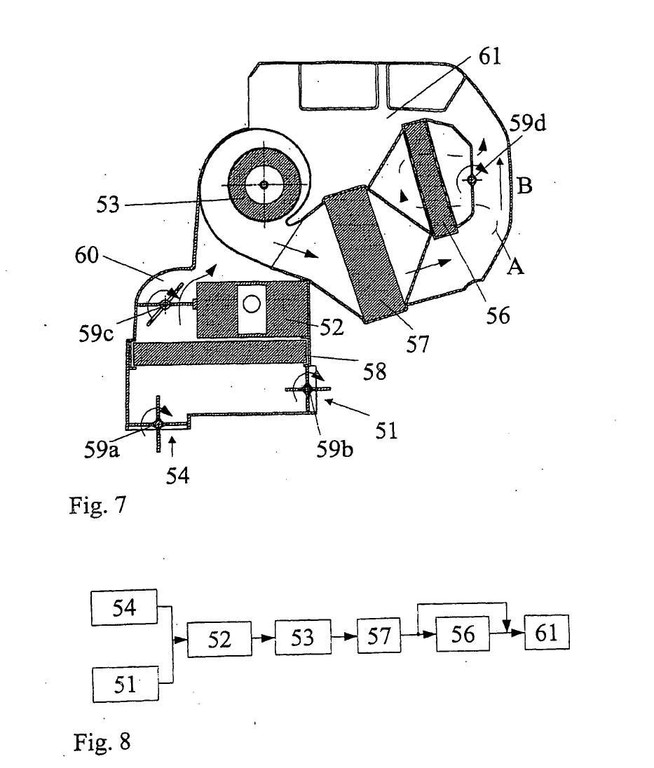

FIG. 7 shows an alternative embodiment of a device for heating air;

FIG. 8 is the flow chart of the device from FIG. 7;

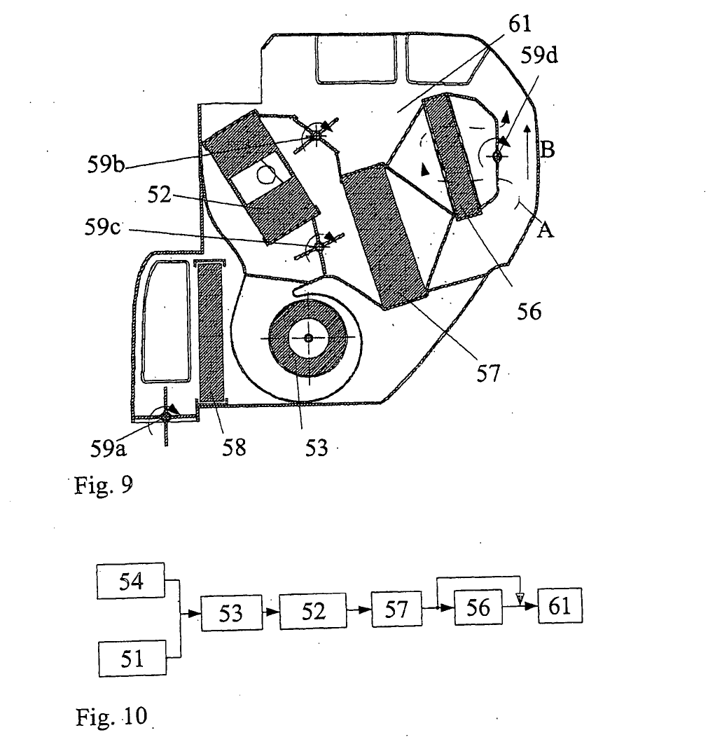

FIG. 9 shows a further embodiment according to the invention of a device for heating air;

FIG. 10 is a flow chart of the device according to FIG. 9;

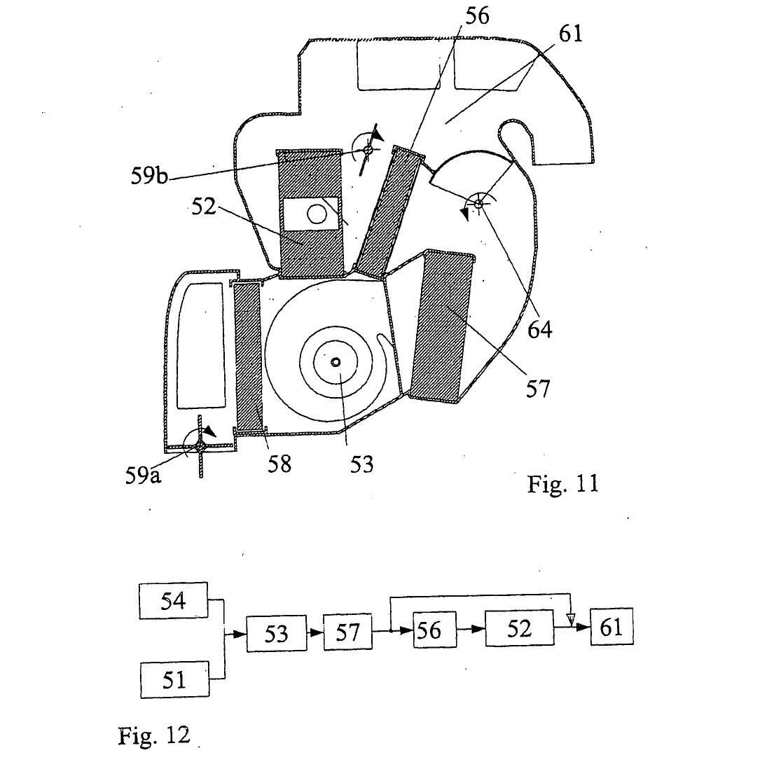

FIG. 11 shows a further exemplary embodiment of the device according to the invention;

FIG. 12 is a flow chart of the device from FIG. 11;

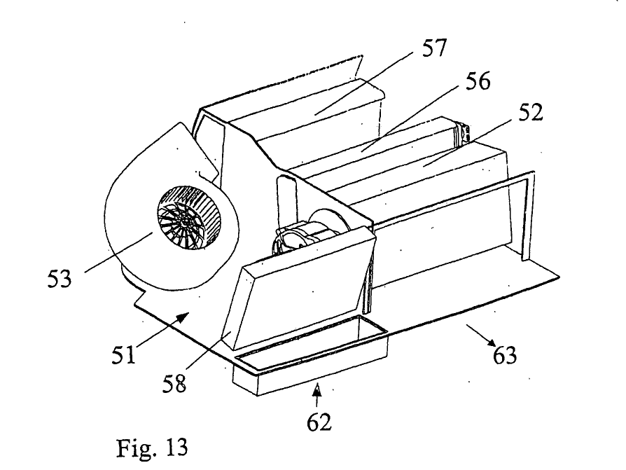

FIG. 13 is a perspective illustration of the device according to FIG. 11;

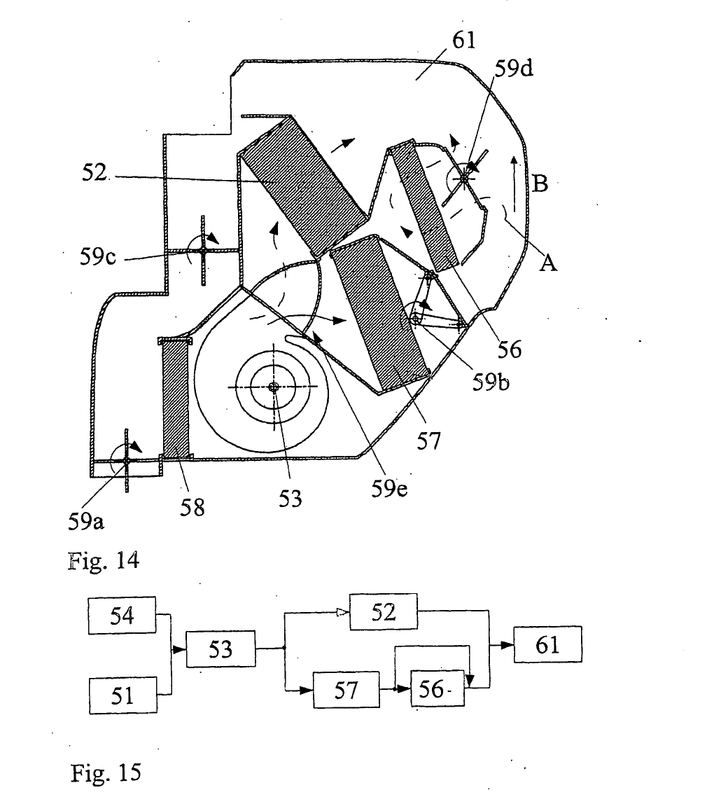

FIG. 14 shows a further embodiment of the device according to the invention for heating air;

FIG. 15 is a flowchart of the device according to FIG. 14;

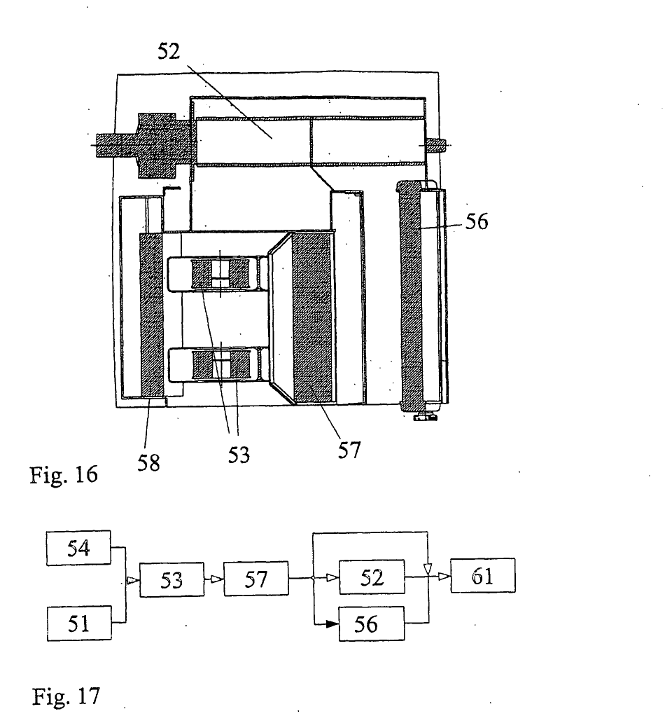

FIG. 16 shows a further exemplary embodiment of the device according to the invention in a plan view;

FIG. 17 is a flowchart of the device according to FIG. 16;

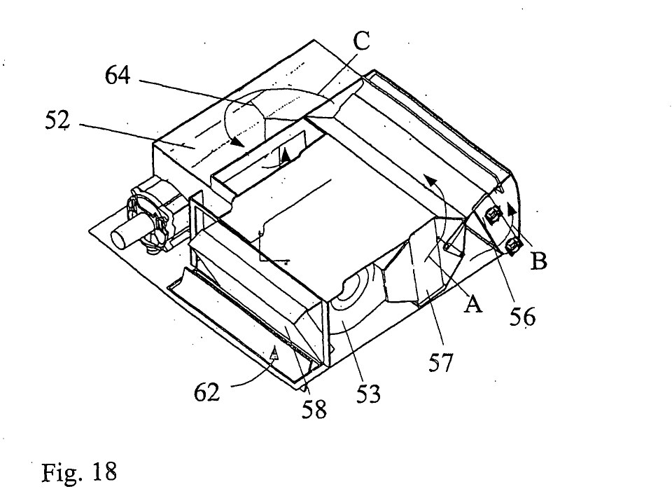

FIG. 18 is a perspective view of the device according to FIG. 16;

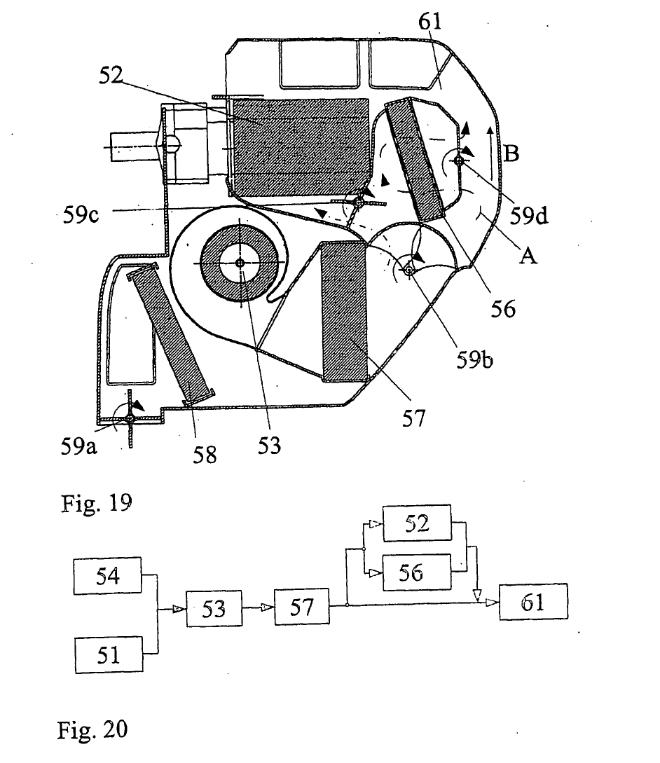

FIG. 19 shows an alternative exemplary embodiment of the device according to the invention for heating air;

FIG. 20 is a flowchart of the device according to FIG. 19;

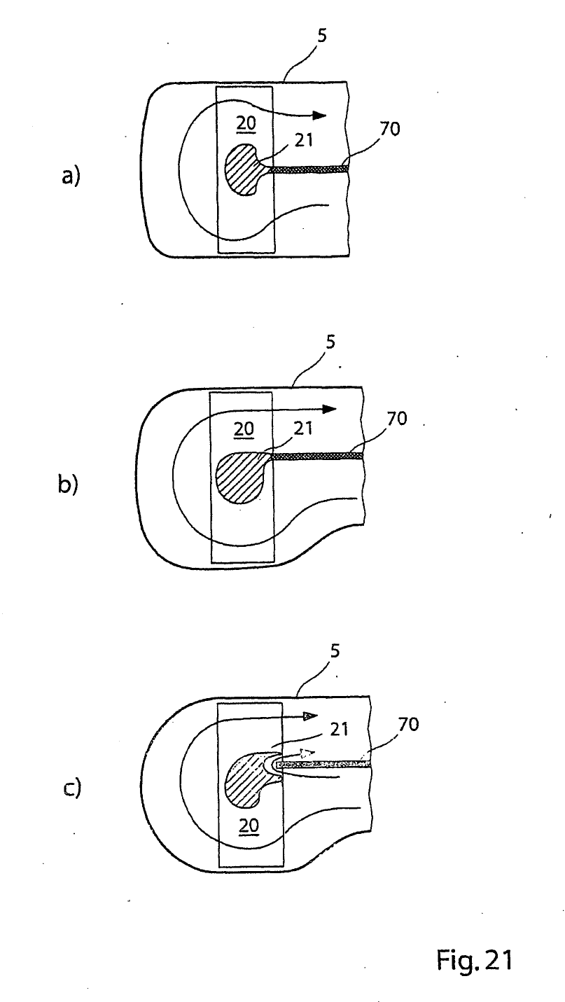

FIG. 21 shows sectional views of heating apparatuses with heat-conducting cores with different cross sections;

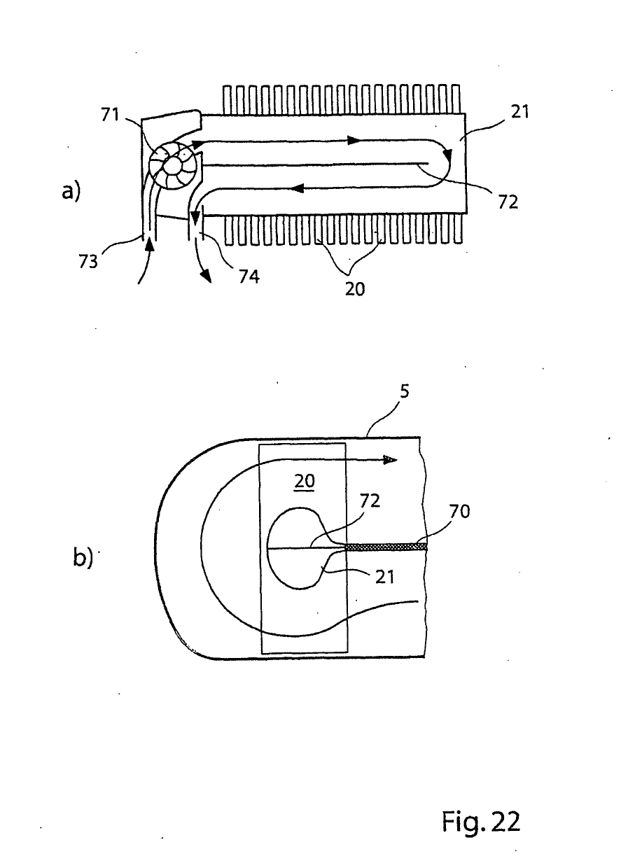

FIG. 22 shows a further preferred embodiment of a heating apparatus of a device according to the invention for heating air in different sectional views;

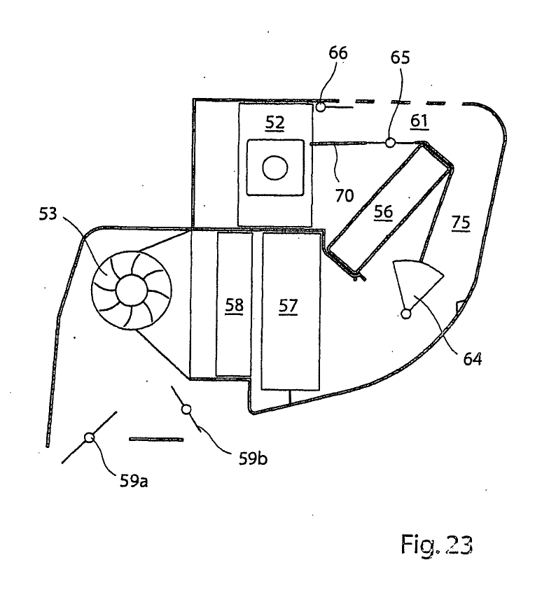

FIG. 23 shows a preferred embodiment of a device according to the invention for heating air in a first operating state; and

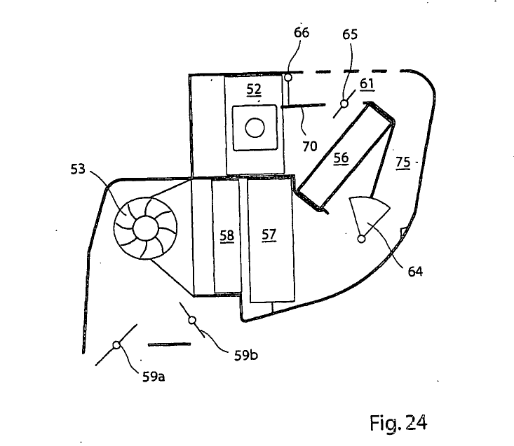

FIG. 24 shows the device according to the invention from FIG. 23 in a second operating state.

FIG. 1 shows a first embodiment of the arrangement of a heating apparatus 1a and of an actuating device 2 according to the present invention for an air-conditioning system. The heating apparatus here has a heat-conducting core 4 from which, according to the embodiment illustrated here, heat exchanger surfaces 1, which are formed from baffle plates, extend in the upward and downward directions.

An actuating device 2, which can be rotated into various positions, as indicated by the arrow, for example by means of a servo motor, is arranged adjoining the upper heat exchanger surface.

According to the present invention, the actuating device 2 may be composed of a rotatably mounted closure flap which adjoins either with the region of contact with the heat exchanger surface 1b of the heating apparatus 1a or which has a contoured or comb structure which engages at least partially in the intermediate spaces of the heat exchanger surface of the heating apparatus.

This arrangement ensures that when the actuating device is closed the air flows completely through the free flow cross section of the heating apparatus. When the actuating device is opened, the so-called bypass to the heating apparatus is opened, as a result of which, in particular when the heating apparatus is not operating, the drop in pressure caused by the reduced flow cross section is reduced. In this context, a large part of the air flows through the flow cross section of the bypass which has been cleared, but a flow through the heating apparatus is not completely avoided.

The flow duct also has the housing wall 5 with which, according to the embodiment illustrated here, the heat exchanger surface of the heating apparatus is in contact.

FIG. 2 shows an alternative embodiment of the arrangement of a heating apparatus 1a and of an actuating device 2. Here, in comparison with FIG. 1, the heating apparatus is rotated through 90 degrees so that the heat exchanger core comes into contact with the actuating device 2 in the closed state. In this position, the air which is fed in the flow path according to the arrows 3 is fed through the free surface of the heating apparatus and fed back into the main flow path, indicated by the arrow 7, by means of a bypass 6.

In the opened state of the actuating device 2, a flow through the heating apparatus 1a is largely avoided.

However, it is to be noted that a flap which completely closes off the open cross section is not provided for the free flow cross section of the heating apparatus either in FIG. 1 or in FIG. 2.

FIG. 3a shows a perspective illustration of a heating apparatus, in particular the heat exchanger surface 20 with a heat-conducting core 21 being shown.

FIG. 3b is a side view of the device illustrated in FIG. 3a in which the essential orientation of the heat exchanger surfaces 20 and the core 21 can be seen.

FIGS. 4a and 4b show an alternative embodiment of the arrangement of the heat exchanger surfaces on a heat-conducting core. Here, the core is arranged essentially in the center of the square baffle plates which lie one behind the other, as a result of which in particular a larger surface for the exchange of heat as compared to the version illustrated in FIGS. 3a and 3b is made available.

FIG. 5 shows a perspective illustration of a device according to the invention for conditioning air for an air-conditioning system, a schematic flow chart for the device according to FIG. 5 being given in FIG. 6.

According to the arrangement illustrated here, fresh air 54 or recirculated air 54 is fed into the device via one or two inlets. In FIG. 5, the feed is also represented by the reference numeral 54 for the fresh air and 51 for the recirculated air. The inlet of the recirculated air is rejoined by a heating apparatus 52, in particular for a stationary-mode heater, which is used for heating, in particular when the engine is stationary.

The air which is fed to the device (fresh air and/or recirculated air) is fed to a vaporizer 57 by mans of the blower 53 in order, for example, to cool the hot external air 54 in the case of summer temperatures. The vaporizer 57 is adjoined by a further heating apparatus 56 which, according to the device illustrated in FIG. 5, is operated as an electric heating apparatus 56. However, according to the invention there is the possibility, in particular when the electric heating apparatus is not used, of bypassing the electric heating apparatus 56 via a bypass (see FIG. 6), and of feeding the air flowing out the vaporizer 57 directly into the mixing space 61.

This mixing space 61 can be seen only symbolically in FIG. 5, adjoining the electric heating apparatus 56.

FIG. 7 shows a further embodiment of the devices according to the invention, a schematic flow chart for the device illustrated in FIG. 7 being represented in FIG. 8.

According to the previous statements it is possible to feed fresh air 54 and/or recirculated air 51 to the device via two inlets. For this purpose, in each case actuating devices 59a, 59b whose position can be changed by means of a corresponding controller are provided at the inlets.

A filter 58, which retains, in particular impurities which are fed into the system via the inlets, is arranged adjoining the inlet region. Said filter 58 is adjoined by a heating apparatus, in particular a stationary-mode heater 52, which according to the invention is equipped with a bypass 60. The actuating element 59c permits the air to be fed out of the inlet directly via a bypass 60 to a housing 53 or, when the actuating devices 59c are in the closed state, it permits the fresh air to be heated with the stationary-mode heater 52. The blower 53 which feeds the air to a vaporizer 57 which is arranged upstream of a heating apparatus 56 is arranged adjoining this region. As already stated above, there is also a possibility here of bypassing the heating element by means of a bypass (cf. FIG. 8), with a further actuating device 59b being arranged in such a way that in the opened state the air has to flow through the flow path described by the arrow A in order to subsequently pass into the mixing space 61. When the actuating element 59b is closed, the air is fed directly into the mixing space 61 according to the arrow B.

FIG. 9 shows a further exemplary embodiment of a device according to the invention with the flow chart represented in FIG. 10.

Here, fresh air and/or recirculated air 51 are fed to the device, with the closed-loop control being carried out by means of the actuating devices 59a. A filter 58, which prevents contamination of the device to a large degree, is arranged adjoining said actuating devices 59a. A blower 53, which feeds the air to the heating apparatus 52, is arranged downstream of the filter. According to the invention, at this position a bypass is arranged which can be opened and closed by means of an actuating device 59c. A vaporizer 57 which, as mentioned above, is positioned upstream of a heating apparatus 56, is arranged adjoining the heating apparatus 52. The heating apparatus 56 is connected into the flow path of the air downstream of the vaporizer by means of an actuating element 59d if the heating of the air stream is desired. The flow path then follows the arrow A according to FIG. 9 and the air then passes into the mixing space 61 adjoining the heating apparatus. If the actuating element 59 is closed, the air coming out of the vaporizer is fed directly along the arrow B to the mixing space 61. According to FIG. 9, the heated air can also be fed directly into the mixing space 61 via a further actuating element 59b downstream of the stationary-mode heater.

According to one particularly preferred embodiment, the device according to FIG. 9 is arranged in the motor vehicle in such a way that in particular the flow of the slipstream is utilized in such a way that the inlet of the device is arranged perpendicular to the direction of flow of the slipstream in such a way that when the motor vehicle is traveling the air flows into the device.

FIG. 11 shows a further exemplary embodiment of the present invention in which the fresh air 54 or recirculated air 51 is fed to the device via an inlet. After the filtering, the air is fed to the blower 53 and is conveyed through the heat exchanger surface of the vaporizer 57. Adjoining the vaporizer, the air is either transported through the heating apparatus and the adjoining stationary-mode heater 52 or it can be transported directly into the mixing space 61 by means of a bypass and the actuating element 64. The air can also be branched off downstream of the heating apparatus 56 according to FIG. 11 by means of the actuating device 59b. Here too, the air is subsequently transported into the mixing space 61.

FIG. 13 is a perspective illustration of the device according to FIG. 11 in which fresh air is fed to the blower 53 via the inlet 62 and the filter 58. Recirculated air is fed to the blower 53 directly via the intermediate space 51. An electric heating apparatus 56 and the stationary-mode heater 52 are arranged adjoining the blower.

FIG. 14 and FIG. 15 show a further exemplary embodiment of an air-conditioning system in which the fresh air 54 and/or the recirculated air 51 are fed via an inlet directly to the stationary-mode heater 52, then to the mixing space 61 or alternatively to the vaporizer 57 and a heating apparatus which is equipped with a bypass, to the mixing space 61, as is apparent in particular from the schematic flow chart according to FIG. 15.

FIG. 14 shows the inlet region with an actuating device 59a and a further actuating device 59c which is arranged adjoining the inlet duct. From the inlet duct, the air is fed through the filter 58 to the blower 53 and can either be fed to the stationary-mode heater 52 or to the vaporizer 57. An actuating device 59b by means of which the air can be fed either to the heating apparatus 56 or directly to the mixing space 61 is arranged adjoining the vaporizer 57. An actuating device 59d, via which heated air can be fed into the mixing space 61, is arranged adjoining the heating apparatus 56.

FIG. 16 and FIG. 17 show a further embodiment of a device according to the invention for an air-conditioning system, in which case air is fed via an inlet region and a filter 58 to the two blowers 53 in accordance with the previous illustrations. From here, the air stream is fed to the vaporizer 57, in which case, according to the embodiment illustrated here, the air stream can be fed directly to the mixing space, which heats up by means of a stationary-mode heater 52 or by means of a heating apparatus 56.

FIG. 18 is a perspective illustration of the device according to FIGS. 14 and 15, the inlet region 62, the filter 58, one of the blowers 53, the vaporizer 57 and the heating apparatus 56 and the stationary-mode heater 52 being shown.

According to FIG. 18, different flow feeding paths are also represented by means of the arrows A, B and C, in particular the arrow A being representative of the feeding of cooled air downstream of the vaporizer 57 without the flow through the heating apparatus 56. The arrow B is a symbolic representation of the feeding of the air through the heating apparatus 56. After this the air is fed via the stationary-mode heater 52, with the air being fed twice through the heat exchanger surfaces by a dividing element 64. After the stationary-mode heater the air is led off via the outlet region at the end of the arrow C.

FIGS. 19 and 20 show an alternative embodiment of the device according to the invention, the fresh air 54 or recirculated air 51 being once more fed to the blower 53 via a filter 58. The vaporizer 57 is arranged adjoining thereto. An actuating device 59b by means of which the air can be fed directly to the mixing space 61 is arranged on the vaporizer 57. Alternatively, the air is fed into the region of the stationary-mode heater 52 or the electric heating apparatus 56, with the air being fed to the respective assembly by means of the actuating device 59b and 59d. According to FIG. 19, the heating apparatus 56 can also be connected into the flow path of the air downstream of the vaporizer between the vaporizer 57 and the mixing space 61, as a result of which the flow passes through the heating apparatus twice given appropriate positioning of the actuating device 59d. In addition, adjoining the actuating element 59 there is the possibility, by bypassing the heating apparatus 56, feeding the air stream directly into the stationary-mode heater 52 and after this directing the air stream into the mixing space 61.

FIG. 21 shows sectional illustrations of different heating apparatuses of the device according to the invention, with the heat-conducting core 21 having respectively different cross-sectional shapes. The heating apparatus according to the invention is adjoined by a limiting element 7 which at least partially bounds the flow path and/or as in the present case, causes the air to be heated to flow through the heating apparatus twice.

The flow path of the air to be heated through the heating apparatus is illustrated in each case by the arrows in FIG. 21, with the heating apparatus being arranged inside a housing which is bounded by walls 5.

FIG. 21a shows an arrangement in which the heat-conducting core 21 which has a heat-conducting connection to the heat-exchanging surfaces 21 is in contact with the boundary element 70. Furthermore, the heat-conducting core 70 is of symmetrical design so that the air which flows through the heating apparatus flows around the core in an essentially symmetrical fashion.

In contrast, FIG. 21b shows a heating apparatus in which the heat-conducting core 21 is of asymmetrical design, with an essentially laminar stream of air also flowing around the core in this case. Compared to the embodiment in FIG. 21a, this embodiment has, however, the advantage that by virtue of the asymmetrical design of the heat-conducting core on the inflow side there is a better flow around the heat-conducting core, in particular as a result of the formation of a ram pressure.

The transfer of heat between the heat-conducting core and the air flowing through the heating apparatus is thus improved by the asymmetrical design of the heat-conducting core without significantly changing the overall dimensions of the heating apparatus compared to the embodiment in FIG. 21a, in particular without making the heat-exchanging surface larger.

FIG. 21c shows a further embodiment of a heat-conducting core in which, in order to avoid material damage to the boundary element 70, there is no contact between this boundary element and the heat-conducting core but rather a free cross section is formed through which part of the air flowing through the heating apparatus flows.

In this way, thermal loading on the boundary element in the region of the heating apparatus is reduced by cooling of the core of the boundary element caused in this region by the part of the air stream so that the efficiency of the transfer of heat can also be improved by virtue of the fact that the heat-conducting core can have an increased temperature compared to the embodiments in FIGS. 21a and b without the risk of material damage to the boundary element occurring.

In addition, in the embodiment according to FIG. 21c the heat-conducting core 21 is also of asymmetrical design corresponding to the core in FIG. 21b so that here too an improved flow around the heat-conducting core 21 causes an improved transfer of heat between the heating apparatus and the air flowing through it.

FIG. 22 shows various sectional views of a further, particularly advantageous heating apparatus of a device according to the invention. According to this, the heat-conducting core 21 has a third flow path which is represented in FIG. 22a by the arrow line. Fresh air passes here via the inlet 73 into a combustion chamber 71 of the heating apparatus in which a combustion process takes place, with the resulting hot exhaust gases being conducted into the heat-conducting core 21 so that the exhaust gas flows through the core in its longitudinal direction twice in parallel in essentially opposite directions and the exhaust gas then emerges from the heating apparatus via the outlet 74.

The third flow path is bound here by the dividing element 72 in such a way that the hot exhaust gas flows through the heat-conducting core 21 over its entire length, with the initially relatively hot exhaust gas flowing through the upper region of the heat-conducting core illustrated in FIG. 22a as a result of the proximity to the combustion chamber 71, as a result of which the upper region of the heat-conducting core is heated up to a greater extent than the lower one. A temperature gradient is thus formed, said gradient being oriented at least partially in the direction from the upper region of the heating apparatus to the lower region of the heating apparatus.

The heat-conducting core 21 is also essentially surrounded by heat exchanging surfaces 20 which are connected in the heat-conducting fashion to the surface of the heat-conducting core 21.

FIG. 22b shows a sectional view of the heating apparatus according to FIG. 22a in which the dividing element 72 can be seen within the heat-conducting core 21, with the temperature of the gas in the region above the dividing element 72 being increased compared to the temperature of the gas in the lower region of the heat-conducting core so that the air flowing through the heating apparatus always has a maximum temperature difference between the heat-conducting core and the temperature of the air in the respective part of the heat-conducting core as it flows through the heating apparatus.

This also permits increased efficiency during the transfer of heat between the hot gas flowing through the heat-conducting core and the air flowing through the heating apparatus.

FIGS. 23 and 24 show a further embodiment of a device according to the invention which has air inlet flaps 59a and 59b for fresh air or recirculated air. The air flowing into the device is firstly fed by a feed device 53 to a filter element 58 for cleaning the air, and subsequently through a vaporizer 57.

After this, the quantities of air conducted into the bypass 75 or the heating apparatus 56 are regulated by the actuating device 64 which is of segmented design. The bypass 75 opens here into the mixing chamber 61 so that the actuating device 64 provides the possibility of conducting air cooled by the vaporizer 57 into the mixing chamber 61 from which the air is then conducted into the passenger compartment of the motor vehicle via known distributor devices.

The air which is conducted into the heating apparatus 56 by the actuating device 64 flows through this heating apparatus, after which the stream of air is conducted is fed through the stationary-mode heater 52 by the actuating device 65, which is in the closed position according to FIG. 23, and the air which is thus heated up passes via this path into the mixing chamber 61. The second actuating device 66 is embodied here in such a way that it is moved into the opened position solely by the air flowing through the heating apparatus 52.

When the actuating device 65 is opened, as is shown in FIG. 24, the air heated by the heating apparatus 56 flows directly into the mixing chamber 61, as a result of which the pressure of the air flowing through the heating apparatus 52 is reduced in such a way that the second actuating device 66 is changed to its closed state so that a flow through the heating apparatus 52 is not substantially completely prohibited.

When the first actuating device 65 is opened, the closure of the second actuating device 66 is also favored by the fact that the second actuating device 66 is changed to the closed state in the manner of a nonreturn valve by an air movement flowing through the heating apparatus 52 counter to the main direction of flow, and in this way air is prevented from flowing back out of the mixing chamber 61 into the heating apparatus 52.

1. An installation arrangement for an air-conditioning system with a heating apparatus, in particular for motor vehicles, having
at least one housing in which air is fed in an at least partially predefined flow path, and
which has at least one heating apparatus and at least one actuating device, with the heating apparatus being arranged in a first flow path and the actuating device being arranged at least partially in a second flow path,
wherein
in at least one position the actuating device virtually completely brings about the flow through the heating apparatus.

2. The installation arrangement for an air-conditioning system with a heating apparatus as claimed in claim 1, wherein
the housing has at least one inlet and at least one outlet for the air.

3. The installation arrangement for an air-conditioning system with a heating apparatus as claimed in claim 1, wherein
the heating apparatus is selected from a group of heating apparatuses which contains heat exchangers, CO₂ heat pumps, heaters which use exhaust gas heat, fuel heater, condensers, stationary-mode heaters, electric heaters, PTC heaters and the like.

4. The installation arrangement for an air-conditioning system with a heating apparatus as claimed in claim 1, wherein
the heating apparatus has a core which conducts heat and whose heat exchanger surface is formed by baffle plates which are arranged at a predefined angle to the main direction of extent of the core, in a heat-conducting fashion on its surface.

5. The installation arrangement for an air-conditioning system with a heating apparatus as claimed in claim 4, wherein
at least part of the surface of the heat-conducting core has a flow of air around it.

6. The installation arrangement for an air-conditioning system with a heating apparatus as claimed in claim 5, wherein
the cross section of the heat-conducting core is such that the flow of the air at least along part of the surface of the heat-conducting core is essentially laminar.

7. The installation arrangement for an air-conditioning system with a heating apparatus as claimed in claim 4, wherein
the cross sectional shape of the heat-conducting core is asymmetrical.

8. The installation arrangement for an air-conditioning system with a heating apparatus as claimed in claim 4, wherein
a free cross section through which some of the air which flows through the heating apparatus flows is formed between the heat-conducting core and an element which adjoins the heating apparatus and at least partially bounds the first flow path.

9. The installation arrangement for an air-conditioning system with a heating apparatus as claimed in claim 4, wherein
a third flow path through which a heating medium flows is arranged within the heat-conducting core.

10. The installation arrangement for an air-conditioning system with a heating apparatus as claimed in claim 9, wherein
the heating medium is a fluid, preferably a gas, and is particularly preferably an exhaust gas of a combustion process.

11. The installation arrangement for an air-conditioning system with a heating apparatus as claimed in claim 9, wherein
the heating medium which flows through the heat-conducting core brings about a temperature gradient across the cross section of the core.

12. The installation arrangement for an air-conditioning system with a heating apparatus as claimed in claim 4 wherein
a temperature gradient of the heat-conducting core is at least partially parallel with a temperature gradient of the air which flows through the heating apparatus.

13. The installation arrangement for an air-conditioning system with a heating apparatus as claimed in claim 1, wherein
the buffer plates of the heat exchanger surface have a basic shape which is selected from a group of shapes which contains squares, rectangles, circles, ellipses, polygons, combinations of the latter and the like.

14. The installation arrangement for an air-conditioning system with a heating apparatus as claimed in claim 1, wherein
the heating apparatus is arranged in a bypass duct.

15. The installation arrangement for an air-conditioning system with a heating apparatus as claimed in claim 1, wherein
the heating apparatus is arranged at a predefined distance from the external wall of the housing.

16. The installation arrangement for an air-conditioning system with a heating apparatus as claimed in claim 1, wherein
the heat exchanger surface of the heating apparatus assumes a predefined angle to the longitudinal axis of the motor vehicle.

17. The installation arrangement for an air-conditioning system with a heating apparatus as claimed in claim 1, wherein
at least one fan, in particular an electric fan, which promotes the movement of air through the device within at least one flow path is provided in the housing.

18. The installation arrangement for an air-conditioning system with a heating apparatus as claimed in claim 1, wherein
the air is fed directly and/or indirectly into the passenger compartment of a motor vehicle through the outlet.

19. The installation arrangement for an air-conditioning system with a heating apparatus as claimed in claim 1, wherein
the actuating device can be moved into at least two positions.

20. The installation arrangement for an air-conditioning system with a heating apparatus as claimed in claim 1, wherein
the actuating device is infinitely adjustable, with the proportion of air which is fed through the heating apparatus and/or past the heating apparatus being changed and in particular closed-loop and/or open-loop controlled depending on the position.

21. The installation arrangement for an air-conditioning system with a heating apparatus as claimed in claim 1, wherein
a second actuating device which essentially prevents a flow of air counter to the main direction of flow of the first flow path is arranged downstream of the heating apparatus in the first flow path.

22. The installation arrangement for an air-conditioning system with a heating apparatus as claimed in claim 21, wherein
the second actuating device is embodied in such a way that it is at least partially opened by the air flowing through the heating apparatus in the main direction of flow.

23. The installation arrangement for an air-conditioning system with a heating apparatus as claimed in claim 21, wherein
the second actuating device has a actuating element which at least partially counteracts an opening movement of the actuating device.

24. The installation arrangement for an air-conditioning system with a heating apparatus as claimed in claim 1, wherein
the actuating devices are selected from a group of actuating devices which contains flaps, swinging flaps, segmented flaps, wing flaps, shutters, in particular iris shutters and the like.

25. The installation arrangement for an air-conditioning system with a heating apparatus as claimed in claim 1, wherein a device for filtering air, in particular in the region of the inlet is provided.

26. The installation arrangement for an air-conditioning system with a heating apparatus as claimed in claim 1, wherein
an closed-loop or open-loop control device which performs closed-loop or open-loop control on, in particular, the quantity of air flowing through is provided on the at least one inlet and/or outlet for the air.

27. The installation arrangement for an air-conditioning system with a heating apparatus as claimed in claim 1, wherein
the air is fed at least partially along a dividing wall adjoining an internal combustion engine, and in that at least one heating apparatus is arranged in particular in this region.

28. The installation arrangement for an air-conditioning system with a heating apparatus as claimed in claim 1, wherein
the device has at least one sensor which is selected from a group of sensors which determine the temperature, pressure, speed such as, for example, the flow rate of a medium, or the position of a component.

29. The installation arrangement for an air-conditioning system with a heating apparatus as claimed claim 1, wherein
the individual elements and/or assemblies of the device are arranged basically one behind the other in the flow path, in which case in particular at least one element and/or one assembly can be removed from the main flow path of the air by means of a bypass.
